(19) United States
(12) Patent Application Publication
(10) Pub. No.: US 2025/0185773 A1
(43) Pub. Date: Jun. 12, 2025

(54) POSITIONABLE WHEELS FOR MOVING OBJECTS OVER STAIRS

(71) Applicant: Akhilesh Surendrakumar Gupta, Gondia (IN)

(72) Inventor: Akhilesh Surendrakumar Gupta, Gondia (IN)

(21) Appl. No.: 18/843,293

(22) PCT Filed: Mar. 1, 2023
(86) PCT No.: PCT/IN2023/050188

§ 371 Date: Sep. 2, 2024

(30) Foreign Application Priority Data
Mar. 3, 2022 (IN) 202221011361

(51) Int. Cl. A45C 5/14; A45C 5/03; A45C 13/26; B62B 5/02

(52) U.S. Cl. CPC A45C 5/146; A45C 5/03; A45C 5/145; A45C 13/262; B62B 5/02; A45C 2005/147; A45C 2013/267; B62B 2301/00

(57) ABSTRACT

The present disclosure is about assemblies containing shiftable parts like three sided open-frames or independent bars with stub-axles. In some embodiments shiftable parts are designed to ‘slide’ within encompassing tubes. In other embodiments shiftable parts are designed to be ‘turnable’ by attaching them on pivots. These shiftable components are used for mounting general wheels or multi-wheel star assemblies on them. Such assemblies can be either attached to or built into movable objects like luggage or robots to facilitate their movement over stairs. When the wheels are positioned to keep the body of the movable object away from the edges of the stairs, the object can be moved upstairs and also downstairs without getting scratched. When the wheels are shifted to another position, the objects can be easily moved over flat surfaces. One of these positions will be for storing the object in lesser space.

### TECHNICAL FIELD

We sometimes need to carry things, objects, luggage, etc. over stairs or steps on the ground. We generally lift things and carry them over stairs or steps. Common luggage, particularly trolley cases, have two or more small wheels to be towed on flat surfaces, but these trolley cases cannot be dragged or pulled over stairs and steps.

Any one of the embodiments presented here or similar embodiments can be attached to or built into movable objects like suitcases, containers, bags, cabinets, machines, etc. These embodiments can also be incorporated into those units that are meant for carrying other objects like trolleys, vehicles, robots, etc.

The assemblies presented here are for positioning wheels by shifting axles or bars carrying those wheels with respect to the objects to be moved over stairs. By employing any one of these or similar assemblies and using a corresponding method, an object can be moved upstairs or downstairs.

### BACKGROUND OF THE INVENTION WITH REGARD TO KNOWN ART

Most people do not have to carry somewhat weighted and sized objects like suitcases over stairs regularly. That's why they are not looking hard for solutions to carry their luggage over stairs. They may not be willing to pay for costly, complex and heavy mechanisms for solving an occasional problem.

Currently, a typical trolley case has two or more small wheels or castors attached to one of the smaller sides of it. This typical case with wheels can be pulled over flat surfaces like paved ground or floors by an extendable and retractable handle or leash. Few trolley cases have somewhat bigger wheels, either for overcoming small obstacles or for carrying heavier weight.

Attempts have been made to develop wheel assemblies that can be retracted into cavities or pockets made for them inside cases to prevent dirt or dust on the wheels from soiling places where these trolley cases are placed. An example of such an attempt is U.S. Pat. No. 6,612,411 B2, which claims a method and device for extending and retracting the wheels of a towable case. Another example is U.S. Pat. No. 7,861,834 B2, which also claims a retractable wheel system for towable baggage.

U.S. Pat. No. 5,306,027, titled ‘Trolley with a retractable wheel assembly’, claims retractable wheel assembly for carrying articles like golf-bags. Wheels are retracted i.e., lifted to keep the trolley stationary.

These trolley cases or trolleys mentioned in previous paragraphs were not designed to be dragged over stairs. Rarely, some trolley cases have big wheels for carrying heavy weight, overcoming obstacles or climbing steps, but these bigger wheels are not desired over flat surfaces.

Some trolley cases have two sets of multi-wheel assemblies instead of ordinary wheels. These assemblies of wheels are generally tri-wheel star assemblies, but quad-wheel star assemblies are also sometimes employed. A tri-wheel star assembly consists of three wheels each at the end of a radial spoke (arm) of a central hub. Such assemblies help move trolley cases over stairs by pulling them.

In other words, a tri-wheel star assembly has three spokes like arms extending radially from its center or hub. Each arm has a stub axle attached perpendicularly. All the three stub axles are parallel to each other. Every stub axle has a wheel attached to it. Thus, each tri-wheel star assembly has a central hub with three wheels attached to it. The axes of all the three wheels are parallel to the axis of the central hub.

These tri-wheel or quad-wheel star assemblies are also sometimes called spider wheel assemblies. These multi-wheel assemblies help us in pulling or dragging trolley cases upstairs or downstairs easily, as compared to simple wheels. But these multi-wheel assemblies make it difficult for the trolley cases employing them to be stored in tight spaces like space under the passenger seats or within overhead stowage bins. These multi-wheel assemblies also make it somewhat difficult to drag such trolley cases over flat surfaces.

U.S. Pat. No. 7,669,862 B2 claims a collapsible spider wheel assembly on a towing device that enables storage of the device in a standard rectangular space. The purpose of this collapsible wheel assembly is to make spider wheels to be protected within the body of the towing device while storing it. Unlike the present disclosure, the axles of these spider wheel assemblies remain fixed near the bodies of the objects.

The U.S. Pat. No. 6,938,740, titled ‘Suitcase with stair roller and brake’, claims a plurality of spaced apart axles which are also fixed. One drawback of this and some other stair climbing designs and devices is the complexities associated with them. These complex mechanisms built into the luggage or cases make them costlier and/or heavier.

Some of the previously patented designs may be easier to operate than some of the embodiments of the present invention. If we make electric battery powered tri-wheel star assemblies for general luggage, that would be easier to operate but would be costlier and heavier. Such electric tri-wheel star assemblies are required in the case of stair climbing robots. People currently are not looking for complex trolleys as those will be costly as well as heavy.

Some existing assemblies and techniques are simpler in design and easier to operate than most of the embodiments presented here but require more space to store the object and/or are not easy to traverse the object on flat surfaces. An example is a simple trolley case with two three-wheel star assemblies.

### OBJECTS OF THE INVENTION

Most embodiments of the present disclosure and related assemblies are designed to provide fairly simple and/or cost-effective solutions for carrying objects over stairs. These solutions are alternatives to manually lifting objects to prevent their sides and edges from rubbing against the edges of stairs or steps on the floor.

As most of the assemblies presented here are reasonably simple, they will require little maintenance. The methods to operate them are also easier. Some embodiments employ assemblies that are not very simple but are easier to operate.

A unit employing any one of these assemblies will operate almost like a normal trolley case while moving over a flat surface. Most of the embodiments described here are designed to be easily incorporated into mass-produced objects like trolley cases or robots without adding a lot of weight and/or cost.

### STATEMENT OF INVENTION

The embodiments of the present disclosure have assemblies of positionable wheels which are mounted on turnable or sliding frames or independent bars acting as axles. These assemblies can be attached to or built into suitcases, robots, containers, and other movable objects to assist in pulling or moving these objects upstairs or downstairs after using the corresponding methods or techniques.

Most assemblies presented here are for sliding or shifting frames that act as axles. Some assemblies are for sliding or shifting separate bars having stub axles. The wheels mounted on these frame-and-axles or separate bars-with-stub-axles can thus be moved further from the main bodies of the movable objects and moved back near to them. Some assemblies are for positioning wheels by turning the axle around the body of the object. Most of these assemblies can increase the distance between the bodies or trunks of the movable objects and their wheels. This increased distance, or merely shifted position of the wheels provides enough space for the edges of the steps in between the body and the wheels. The wheels can be retracted or moved back to the initial position for easy traversing on flat surfaces and/or for storing in smaller spaces.

The main component in most of the embodiments is an open three-sided frame with the middle side serving as an axle for the wheels. This frame, along with the ordinary wheels or multi-wheel star assemblies, can be extended, i.e., pulled as much out of the encompassing tubes or sockets as designed, and retracted back into them. The encompassing tubes are attached to or built into the movable object's body. These assemblies and related methods are helpful in avoiding contact between the main bodies of movable objects and the edges of the stair-steps.

### A SUMMARY OF INVENTION

The assemblies and methods presented here for positionable wheels are designed to be simple, easy to use, economical and lightweight. These assemblies are to help with moving objects over stairs.

The main part of most of the embodiments is a shiftable frame that can be extended and retracted. The word ‘frame’ generally means a four-sided closed frame. But the frame used here is a three-sided or ‘open’ frame, meaning the fourth side that closes a typical frame is absent as it is not required. This is similar to three-sided door frames.

In these open-frames, two identical sides are connected by a middle side. The middle side is preferably perpendicular to the two identical sides. These two opposite sides are mirror images of one another and are also parallel to each other. The middle side connects to the two identical sides at their corresponding ends. So, from one angle, a typical open-frame appears to be square-U-shaped. The middle side may not simply be straight from end to end; it may have bends or curvature where wheels are not attached. The two parallel sides attached to the middle side also may not be straight; they may have bends, curvature, etc., as is the case in an exemplary embodiment.

The two parallel sides slide within two encompassing (outer) tubes that are also parallel. These tubes can be attached to or built into movable objects like suitcases, containers, boxes, robots, etc.

On the middle side, two ordinary wheels or multi-wheel star assemblies are mounted, spaced apart. Thus, the middle side acts as an axle. This extendable and retractable ‘open-frame’ that acts as an axle can be visualised as a ‘shiftable open-frame’ or ‘sliding open-frame’.

In most embodiments, we can slide the shiftable open-frame with respect to the main body of the object. So, ordinary wheels or multi-wheel star assemblies mounted on the open-frame are moved away from the main body of the object or near to it. One embodiment is having independently sliding ‘bars with stub axles’ with two ordinary wheels or multi-wheel star assemblies mounted on their free ends.

In one embodiment, we can turn or shift the open-frame with ordinary wheels or multi-wheel star assemblies around the object to be moved. Another embodiment is using independent turnable bars with stub axles attached to their free ends. Each of these stub axles will support either a simple wheel or a multi-wheel star assembly.

By sliding or turning the open-frame or the ‘bars with stub axle’, a space is created between the main body of the object and the wheels or wheel assemblies. This space allows for the edges of the steps of stairs so that the object can be moved upstairs or downstairs without getting scratched.

We can retract the open-frame so as to bring the wheels or multi-wheel star assemblies near to the object to store it in relatively small spaces, e.g., below the seats of passenger trains or in the overhead stowage bins of airplanes. This position may be better to traverse the object over flat surfaces.

### BRIEF DESCRIPTIONS OF THE ACCOMPANYING DRAWINGS

We can get a concise understanding of the various embodiments presented here by reading the following brief descriptions of the attached drawings. The drawings are not limitations of the present invention, they are for the purpose of illustration only.

Three simple perspective views are used to quickly convey the design of an exemplary embodiment. As it is convenient to show details in side views for the assemblies presented here, most of the figures are side views. Only two views are front views, only to emphasize what cannot be clearly explained in a few words using just side views.

An exemplary embodiment is shown in FIGS. 1, 2, 3, 4, 5 and 6. Other figures show other embodiments or variations of them. Lots of views are not in an upright but in a slanted position, as travel cases are generally towed in this position.

FIG. 1 is a simple perspective view showing two wheels 20 mounted on a shiftable open-frame 50. This open-frame 50 is in the extended position, which is as much out of the body 80 as designed. This shiftable open-frame 50 along with its guides are the most important feature of this embodiment. These parts mainly distinguish between prior art and this embodiment.

The upper double-headed arrow in FIG. 1 shows the direction of shifting or telescoping of the adjustable handle-frame 90 which is common in most trolley cases. The lower double-headed arrow in FIG. 1 shows the direction of shifting or sliding of the shiftable open-frame 50. Directions of both the shifts are parallel to each other in this embodiment.

FIG. 2 is another simple perspective view, like FIG. 1 of the exemplary embodiment, but with hidden lines showing the complete shiftable open-frame 50, as well as the complete handle-frame 90. These hidden lines emphasize that the open-frame 50 is an extendable as-well-as retractable part like the handle-frame 90.

As FIG. 2 is a simple view, the hidden lines showing guides/sockets for the handle-frame 90 as well as for shiftable open-frame 50 are not shown. The locking mechanisms for the retracted positions and the extended positions of the open-frame as well as of the handle-frame are also not shown in this picture.

FIG. 3 is yet another simple perspective view of the exemplary embodiment.

The open-frame 50 shown in FIG. 3 is in the retracted position, i.e., as much inside the body 80 as designed. This is the position or state which is similar to the generally available trolley cases, travel-luggage, etc., Locking mechanisms and guides for the shiftable open-frame 50 and the handle-frame 90 are not shown in this picture as well.

FIG. 4 is a side view of the exemplary embodiment. The open-frame 50 is in the retracted position, similar to the position shown in FIG. 3. As the open-frame 50 is retracted within the body 80 as much as designed, the two wheels 20 mounted on the open-frame 50 are closest to the body 80.

Mechanical locking components 40, 42 and 44 for the extended position of open-frame 50 are shown disengaged in FIG. 4. Here locking for the retracted position of the open-frame 50 is facilitated by the attractive forces of magnets 30 and 32 on each other.

The two outer sides of the three-sided open-frame 50 slides within two parallel encompassing tubes 60. These two tubes are built in the body 80. The two parallel built-in encompassing tubes 92, in which the two poles of the handle-frame 90 slide, are also shown in FIG. 4.

FIG. 5 is the front view of the exemplary embodiment. The open-frame 50 is in the retracted position. Its sides are inside the encompassing tubes or sockets 60 built in the body 80. Hence, the two wheels 20, which are attached to the shiftable open-frame 50, are near or closer to the body 80. This position is similar to those shown in FIGS. 3 and 4.

The FIGS. 5 and 4 together form a set of front and side views of the exemplary embodiment. The small side from where the handle-frame 90 goes in the main body 80 of the trolley case is the upper side. The small side from where the shiftable open-frame 50 goes into the main body 80 of the trolley case is the lower side. The upper side is slanted away from the camera as compared to the lower side, which is nearer to the camera. The top face from where the case is opened is in the front. The bottom surface on which we generally keep the case, while opening it, is away from the camera.

FIG. 6 is a side view of the exemplary embodiment. In this figure, the open-frame 50 is in the extended position i.e., as much out of the body 80 as allowed by the design. This position is similar to the position shown in FIGS. 1 and 2. The increased space and the bend in the open-frame 50 provide for the edges 104 of the stairs 102. Thus, while pulling or dragging the luggage up on the stairs 102, we can avoid the body 80 getting rubbed or scratched by the edges 104 of the stairs 102.

FIG. 7 is a side view of a variant of the exemplary embodiment. The open-frame 52 is shown in the retracted position. So, the wheels 20 on it are closer to the body 80, ideal for pulling the case over flat surfaces. The locking mechanism employs six magnets. Two magnets are embedded within the encompassing tube 62 on one side of the body 80, and similarly, two other magnets are embedded within the encompassing tube 62 on the other side of the body 80. Two magnets are embedded in the shiftable open-frame 52, one on each side.

In FIG. 8 which is another side view of the variant of the exemplary embodiment, here the open-frame 52 is in the extended position i.e., as much out of the body 80 as allowed by design. The strong magnets 36 and 38 lock with each other to keep the extended position of the open-frame 52. It is evident from FIG. 8 that the space between the wheels 20 and the body 80 of the luggage has increased because we have extended (pulled) the open-frame 52 away from the body 80 from the retracted position shown in FIG. 7.

FIG. 9 is a side view of an alternative embodiment. In this embodiment, the open-frame 54 can be turned around the pivot 70 in the direction of the hollow arrow. A set of two wheels 20 are attached to the open-frame 54. A strong magnet 48 embedded in one side of the open-frame 54 is locked with another strong magnet 44 embedded in that side of the body 80. Another strong magnet 48 embedded within the other side of the open-frame 54 is locked with another strong magnet 44 embedded within the other side of the body 80. This keeps the open-frame 54 with two wheels 20 in a position that is parallel to the longest side of the body 80.

FIG. 10 is another side view of the alternative embodiment. After turning the open-frame in the direction shown by the hollow arrow in FIG. 9, we get the position shown in FIG. 10. A strong magnet 48 embedded in one side of the open-frame 54 is locked with another strong magnet 46 embedded in that side of the body 80. Another strong magnet 48 embedded within the other side of the open-frame 54 is locked with another strong magnet 46 embedded within that other side of the body 80. This keeps the open-frame 54 with two wheels 20, in a position that is perpendicular to the longest side of the body 80.

FIG. 11 shows another embodiment, which is similar to the exemplary embodiment. The exemplary embodiment has two simple wheels 20 mounted on the middle side of the shiftable open-frame 50, while this embodiment has two three-point star hubs 26 instead of simple wheels. Three wheels 24 are mounted on each of these two hubs 26.

In a three-point star hub, three spokes like arms extend radially from its center. In other words, a three-point star hub looks like a three-point star. A wheel is attached at the end of each of its three arms. Thus, each tri-wheel star assembly has three wheels 24, mounted to its central hub 26.

FIG. 12 shows another embodiment, which is similar to the embodiment shown in FIGS. 7 and 8. The embodiment shown in FIGS. 7 and 8 has two simple wheels 20 mounted on the middle side of the shiftable open-frame 52, while this embodiment has two three-point star hubs 26 mounted on the middle side of the shiftable open-frame 52. Each of these hubs supports a set of 3 wheels 24.

FIG. 13 is a side view of the preferred embodiment. Here the main part is the shiftable open-frame 56, which is a three-sided open-frame that acts as an axle. In this embodiment, the outer two sides of the shiftable open-frame 56, are curved as seen in this side view. The outer two sides of open-frames are without curvature in most other embodiments.

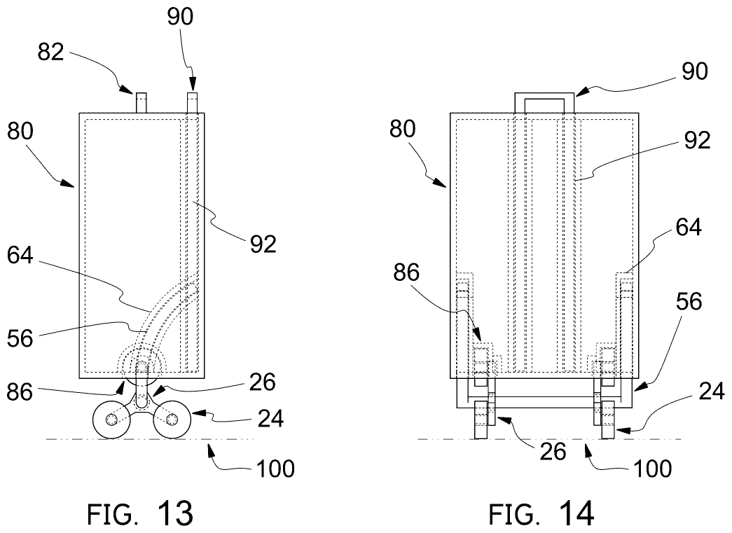

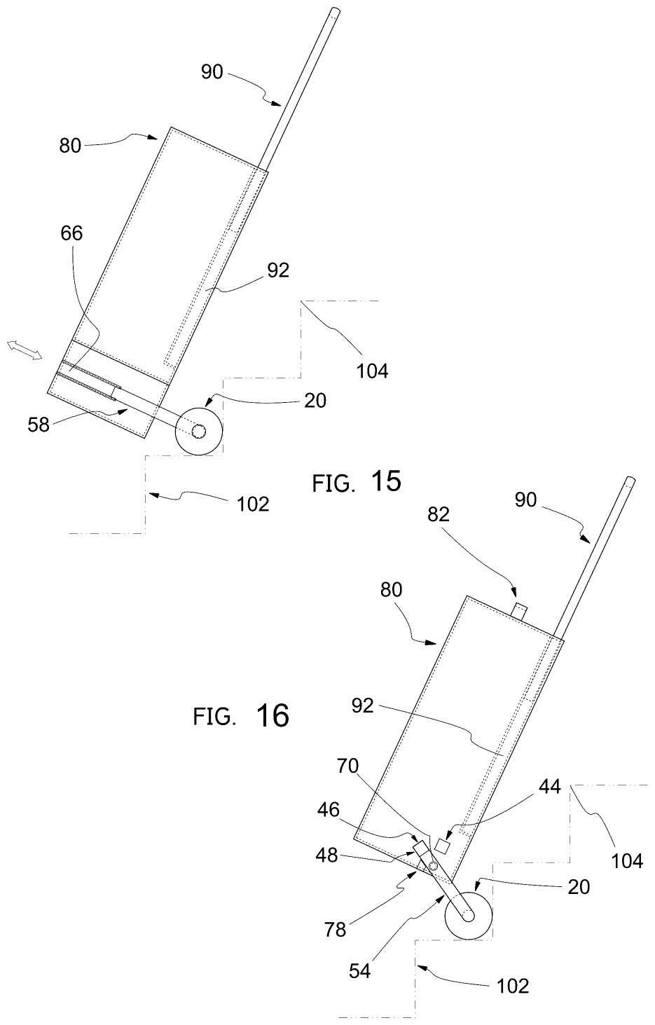

On either side of the bottom of the trolley case shown in FIG. 13, there is a pit 86. A pit 86 is like a recess or a pocket that can accommodate a wheel 24. The open-frame 56 is in the retracted position as shown in FIG. 13. In this position, there is a wheel 24 in each of the pits 86. Each of the wheels 24 which are in the pits 86 is mounted on one of the three-point star hubs 26. As these two wheels 24 (the upper one as shown) are in the pits 86, their respective hubs 26 cannot rotate. The other two wheels of both the tri-wheel star assemblies are touching the ground, as shown in this figure. This position is ideal for pulling the trolley case on flat surfaces and for keeping the trolley case vertically at rest, as shown in this figure.

FIG. 14 is a front view of the preferred embodiment. FIG. 14 forms a set with FIG. 13 to describe the retracted position of the open-frame 56. An upper wheel 24 mounted on a three-point star hub 26 is in the pit 86 that is near to it. Another upper wheel 24 mounted on another three-point star hub 26 is in the pit 86 that is near to it. A lower wheel 24 attached to a three-point star hub 26 is hiding another lower wheel 24 of the same assembly. That is also the case for the other tri-wheel star assembly; i.e., one of its lower wheels 24 is hiding the other lower wheel 24 of the same assembly.

FIG. 15 is a side view of the yet another embodiment. Here, two independent bars 58 slide within the channels 66 on both the longer sides of the trolley case. The advantage of using two independent bars instead of an open-frame is that the wheels may be completely retracted inside the boundary of the case without complicating design. This facilitates the storage of the trolley case in tighter spaces. But an open-frame can also be used in this manner.

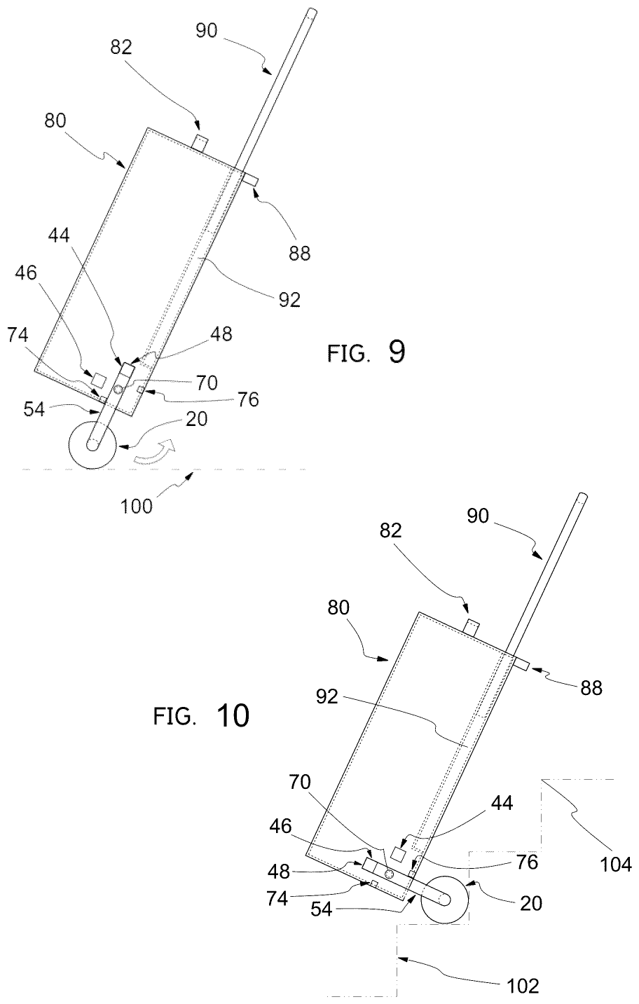

FIG. 16 shows an embodiment that is similar to the embodiment shown in FIGS. 9 and 10. It is in a state similar to FIG. 10, i.e., for pulling the trolley case over the stairs. FIG. 16 shows that the angle between the open-frame 54 and the body 80 may not be exactly perpendicular, i.e., 90 degrees, as shown in FIG. 10.

### DETAILED DESCRIPTION OF THE INVENTION WITH REFERENCE TO DRAWINGS

Various embodiments of this invention can be understood by their following descriptions together with attached drawings. The embodiments discussed here and their respective drawings are for the purpose of illustration only, these are not a limitation of the present disclosure. The word ‘bar’ not just represents ‘bar with non-circular cross-section’ but also ‘thick stick with non-circular cross-section’ or ‘rod preferably with non-circular cross-section’.

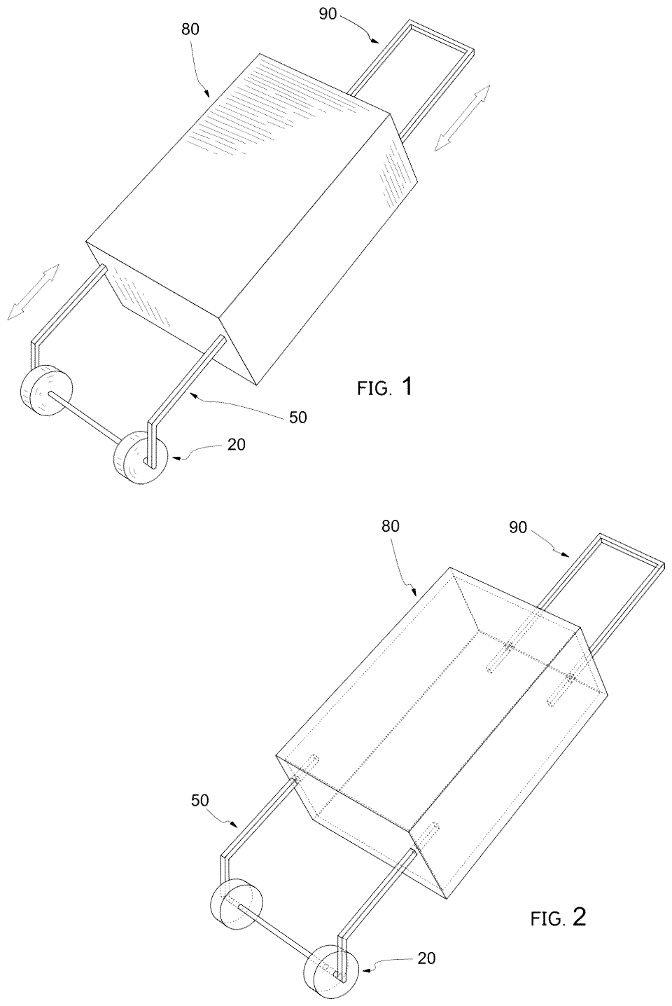

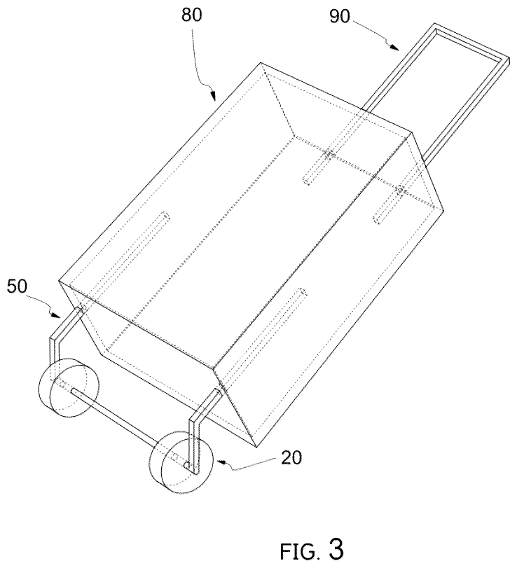

FIGS. 1, 2, 3, 4, 5 and 6 illustrate an exemplary embodiment. The shiftable open-frame 50 shown in these figures is a three-sided open-frame. The middle side of this three-sided open-frame acts as an axle for the wheels 20. Looking at FIGS. 1, 2, 3, and 5, we can see that these two wheels 20 are spaced apart from each other. One wheel 20 is near one end of the middle side, while another is near the other end of the middle side. The outer two sides of this frame are bent at an angle towards the bottom of the trolley case. The extent of the angle is the same for both outer sides. The extent or degree of this angle as shown in these figures is representative only and can be changed in various embodiments. This angle adds some space between the body 80 and the wheels 20 for the edges of the stairs. This shiftable open-frame 50 with guides 60 and two wheels 20 is the main component of the exemplary embodiment.

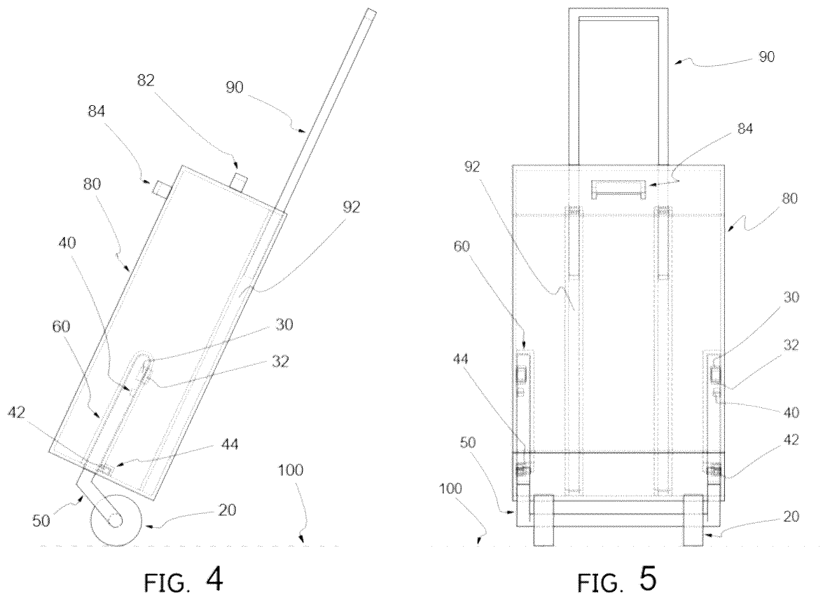

Here, guides or sockets are stationary and parallel channels or encompassing tubes within which parts like the shiftable open-frame 50 and the handle-frame 90 slide. The two parallel built-in encompassing tubes 92, in which the two poles of the handle-frame 90 slide, are shown in FIGS. 4, 5, and 6. This is similar to commonly available trolley cases.

The two sides of the three-sided open-frame 50 slide within two parallel and stationary encompassing tubes 60, as shown in FIGS. 4, 5, and 6. In other words, such built-in tubes 60 may be thought of as sockets or channels designed for receiving the two sides of the three-sided open-frame 50 within them. These stationary tubes 60 also support the open-frame 50 in addition to facilitating their sliding. These sockets or tubes might be built into or fastened to movable objects.

In the extended position as shown in FIGS. 1, 2, and 6, the open-frame 50 is as much out of the body 80 as designed. In the retracted position, as shown in FIGS. 3, 4, and 5, the open-frame 50 is as much inside the body 80 as allowed by design.

The notches 40 shown in FIGS. 4, 5, and 6 are on both sides of the shiftable open-frame 50. For each notch 40, there is a plunger 42, which is housed in the cavity 44 built in the encompassing tube 60 on the same side.

Two magnets 32, shown in FIGS. 4, 5, and 6, are embedded in the two encompassing tubes 60, one on each side of the trolley case. Two magnets 30 shown in FIGS. 4, 5, and 6 are embedded in the two outer sides of the shiftable open-frame 50.

In the retracted position shown in FIGS. 4 and 5, the magnet 30 on one side is near the magnet 32 on its side, while the other magnet 30 on another side is near the magnet 32 on its side. So, we have two identical pairs of magnets 30 and 32 as seen in FIG. 5. In both pairs, the surfaces of magnets 30 and 32, which are near each other, are opposite in polarity. Thus, in both the pairs, the magnets 30 and 32 are attracted to each other. These magnets remain near each other unless we extend the open-frame 50 by pulling it outward of the body 80. These magnets, when they are near each other, prevent the open-frame 50 from getting extended (sliding outward) while lifting the luggage. In the retracted position shown in FIGS. 4 and 5, the notches 40 are away from the plungers 42 on both sides of the trolley case.

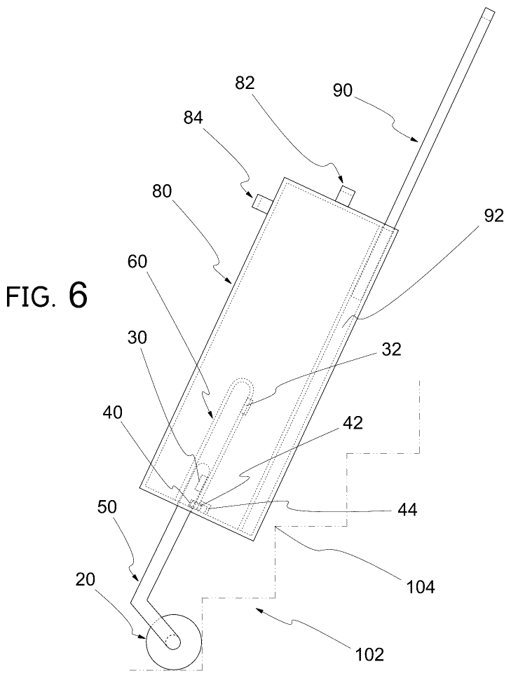

It is evident from FIG. 6 that the space between the wheels 20 and the body 80 of the luggage has increased because we have extended (pulled) the open-frame 50 away from the center of the body 80 from the position shown in FIGS. 5 and 4. The plungers 42 are in the encompassing tubes 60 which are attached to the body 80. These plungers 42 are positioned in the corresponding notches 40 of the shiftable open frame 50. This prevents the open-frame 50 from getting retracted by locking it to the body 80.

The shiftable open-frame 50 carrying wheels 20 are shown bent towards the back of the case, facing stairs 102. The extended position and the angle of the bend create a space between the body 80 and the wheels 20, where the edges 104 of the stairs 102 are accommodated. As a result, the chances of the body 80 being scratched or rubbed by the edges 104 of the stairs 102 are reduced while dragging the luggage, box, etc. over the stairs 102. Hence, this position is ideal for pulling the object over stairs.

The handle 84 is positioned in such a way, to make it easy to pull the luggage up while holding the axle, i.e., the middle side of the shiftable open-frame 50, with one foot. So, by holding the open-frame 50 by keeping his or her foot over it while lifting the trolley case by the handle 84, a person can extend the axle and wheels away from the body of the luggage.

By doing this, the magnets 30 that are embedded in the shiftable open-frame 50 move away from the magnets 32 that are attached to the body 80. The sets of these two magnets 30 and 32 were locked in the open-frame's retracted position, as shown in FIGS. 4 and 5. We bring the notches 40 opposite the plungers 42 by pulling the trolley case up. Now, by sliding the plungers 42 into the respective notches 40, we will be able to lock the open-frame 50 in the extended position, as shown in FIG. 6. To make this procedure simpler, we can have spring-loaded plungers that automatically slide into the notches.

When we again want to drag the trolley case on a plain surface 100, like a floor or paved ground, we will pull back the plungers 42 from the notches 40. Devices or mechanisms to pull the plungers back are not shown in the drawing. There could be simple notches or slots in the body to access the plungers. The plungers may have serrated surfaces or tabs for sliding them. We may have the plungers 42 with springs pushing them outward and a mechanism, strings, etc. to pull the plungers 42 back.

After retracting the plungers 42, we can use the cumulative weight of the body 80 and the things in it to slide (retract) the extended open-frame 50 inside the body 80 if the trolley case is on its wheels 20. If the cumulative weight of the body 80 is not enough, then we may push the body 80 downwards to retract the open-frame 50 inside the body 80. If the trolley case is not on wheels, we can push the shiftable open-frame 50 in the body 80 with our hand(s). This will return the position shown in FIG. 6 to the position shown in FIG. 4.

When the open-frame 50 is in the retracted position, the body of the luggage is lower, i.e., near the ground. The center of gravity of the whole movable luggage is thus lower in this position, which helps with stability while moving over rough surfaces. So, this position is ideal for pulling the case over most surfaces that are reasonably flat, but not over stairs. The space required for storage is also less in this position.

Instead of having a pair of magnets 30 and 32 on both sides, we can have just one pair of magnets on any one side. In other words, a magnet 30 can be embedded in any one side of the shiftable open-frame 50, and a magnet 32 can be embedded in the encompassing tube 60 on that same side of the body 80. Similarly, we can have just one set of a notch 40 and a plunger 42 on any one side. In other words, we can use just one set of locking mechanism for the retracted position and just one set of locking mechanism for the extended position of the open-frame 50.

The arrangement requiring a slot and a plunger along with two magnets can be replaced by just two slots and a plunger. Moreover, we may have just one slot and two plungers.

The handle 82 is not shown in FIG. 5, as it would be largely overlapped by the identical handle 84 in this view.

It is evident from this picture that there are two wheels 20 in this embodiment, but we can have more wheels in between the two wheels 20 on the shiftable open-frame 50.

Instead of a shiftable open-frame 50, we can have a set of two independent bars. These bars will be sliding in the built-in encompassing tubes 60, which are on either side of the body 80 as shown in FIG. 5. Each of these independent bars has a stub axle (a plain thick pin) attached perpendicularly to it on its free end. On each of these two stub axles, a wheel 20 is mounted.

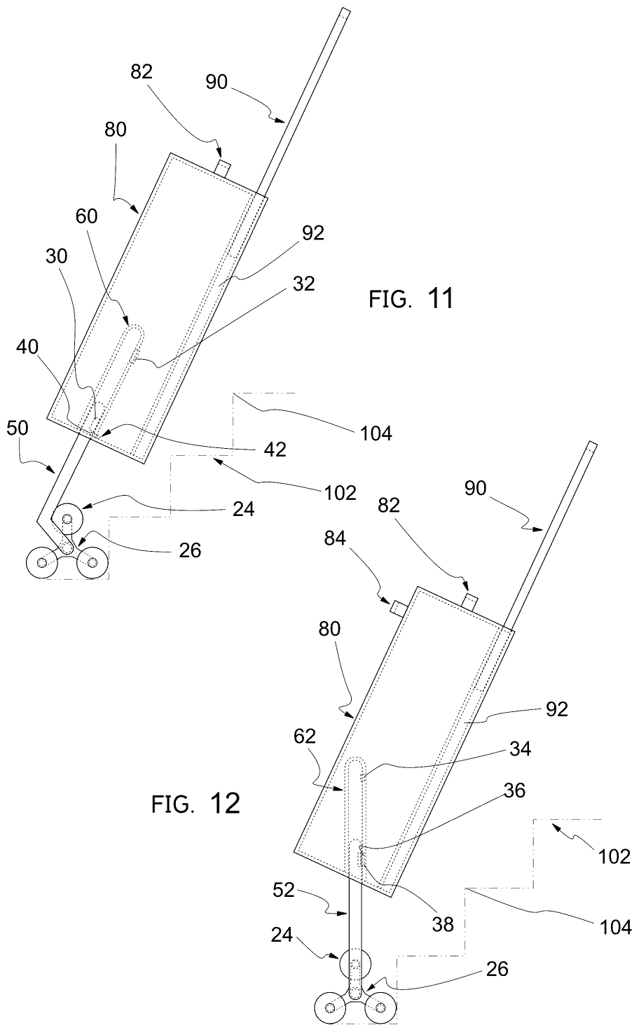

An embodiment similar to the exemplary embodiment is shown in FIG. 11. Here, two three-point star hubs 26 instead of wheels 20 are mounted on the middle side of the shiftable open-frame 50. Three wheels 24 are mounted on each of the three-point star hubs 26. So, these two tri-wheel star assemblies are employed in this embodiment instead of the regular two wheels 20 employed in the exemplary embodiment; the rest of the parts and mechanisms are similar. FIG. 11 shows the plungers 42 in the respective notches 40 to lock the open-frame 50 in the extended position. Similar locking arrangements were explained earlier.

Instead of the shiftable open-frame 50, we can have two independent shiftable bars. These bars can be extended out of the body 80 and pushed back into it to the extent possible by the design. The free ends of each of these bars will have a stub axle attached to them. A three-point star hub 26 will be mounted on each of these stub axles. Three wheels 24 will be mounted on each three-point star hub 26. Moreover, we can have just one independent extendable bar with more than one wheel or more than one tri-wheel star assembly.

There can be magnetic locking for the extended position and mechanical locking for the retracted position of the handle-frame 90, which are not shown in any figure. The stoppers that keep the open-frame from falling out of the encompassing tubes are also not shown.

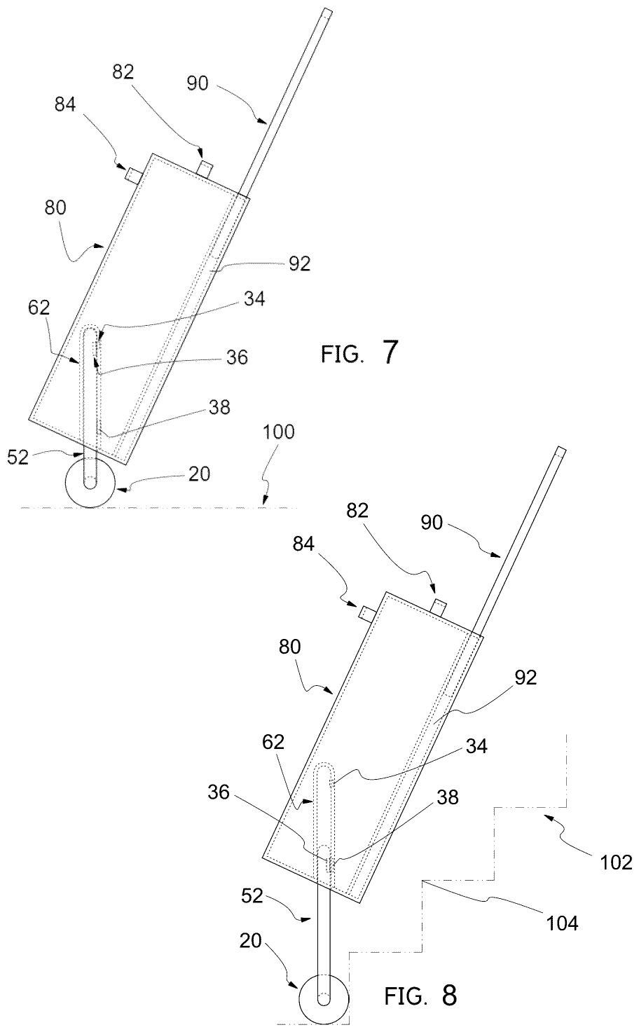

A variant of the exemplary embodiment is shown in FIGS. 7 and 8. A set of wheels 20 are attached to the open-frame 52 that can be extended and retracted at an angle (e.g., diagonally) away from the body 80 and pushed back near to it.

The two outer sides of the three-sided shiftable open-frame 52 which are parallel to each other, slide within the two encompassing tubes 62 (sockets or channels). These tubes 62 are also parallel to each other and are built in the body 80.

FIG. 7 shows that the strong (bigger) magnet 36 is away from the other strong magnet 38. This strong magnet 36 is near the smaller (weaker) magnet 34 to lock the open-frame 52. Because of the smaller magnet 34, the total force needed to extend the open-frame 52 is less, but it is enough to keep the open-frame 52 locked in the retracted position while lifting the trolley case.

The retracted position shown in FIG. 7 is ideal for pulling the object over a flat surface 100, as in this position the main body 80 is lower, i.e., near the ground, as compared to the extended position shown in FIG. 8. This lowers the centre of gravity of the entire movable object and aids in avoiding toppling by small obstacles.

The handle 84 is fixed in a position so as to make it easy for us to pull the luggage up while holding the middle side of the open-frame 52 with our foot. By doing this, the strong magnet 36 is moved away from the smaller magnet 34. By continuing to pull the luggage up, we bring strong magnets 36 and 38 near to each other, and they lock in the extended position of the open-frame 52 as shown in FIG. 8.

The strong magnets 36 and 38 lock relatively strongly in the extended position of the open-frame 52. This prevents the open-frame 52 from retracting due to the combined weight of the body 80 and its contents.

In the extended position, the increased space between the body 80 and the wheels 20 allows for the edges 104 of the stairs 102. So, while pulling or dragging the trolley case over the stairs 102, the body 80 does not get rubbed or scratched by the edges 104 of the stairs 102.

We may use notches and plungers for the extended position and a set of magnets for the retracted position, as used in the exemplary embodiment. Or, to avoid magnets completely, we may use two notches, one for the retracted position and one for the extended position, and a plunger to lock in any one of these notches at a time.

Instead of a shiftable open-frame 52, we can have a set of two independent bars of any cross-section, preferably non-circular. Each bar will have a perpendicularly attached stub-axle to support a wheel.

An embodiment similar to the variant of the exemplary embodiment is shown in FIG. 12. On the middle side of the shiftable open-frame 52, two three-point star hubs 26 are mounted. A wheel 24 is mounted on a stub-axle attached to each arm of a three-point star hub 26. So, there are two tri-wheel star assemblies in this variant instead of two wheels 20; the rest of the things are similar in this embodiment and the variant of the exemplary embodiment.

Instead of the shiftable open-frame 52, we can have two independent (separate) extendable bars of any cross-section, preferably non-circular. These bars can be extended (similar to variant of the exemplary embodiment) at an angle, e.g., diagonally away from the body 80 and pushed back (retracted) near it. Each of these bars will have a stub-axle attached to their free ends. One three-point star hub 26 will be mounted on the stub-axle of each extendable bar. Three wheels 24 will be mounted on each of these three-point star hubs 26.

An alternative embodiment is shown in FIGS. 9 and 10. In this embodiment, the open-frame 54 is designed to be turned around the pivot 70.

The hollow arrow in FIG. 9 shows the direction for turning the open-frame 54 towards the bottom of the trolley case. Here, the bottom of the trolley case is the surface on which we keep it to open or store it. By turning the open-frame 54, we position the wheels 20 mounted on it so that the distance between the body 80 and the edges 104 of the stairs 102 increases. The increased distance creates enough space for the edges 104 of the stairs 102 while the trolley case is being dragged over the stairs 102 as shown in FIG. 10.

A powerful magnet 48 is embedded in one side of the open-frame 54, while another powerful magnet 48 is embedded on the other side of the open-frame 54. Two powerful magnets, 44 and 46, are embedded in one side of the body 80, around the pivot 70. Similarly, another set of these magnets 44 and 46 are embedded on the other side of the body 80.

In the position shown in FIG. 9, the two magnets 48 are strongly attracted to the two powerful magnets 44, which are embedded in the body 80 on two opposite sides. This keeps the open-frame 54 with two wheels 20 locked in a position that is parallel to the longest side of the body 80.

The position depicted in FIG. 9 is preferable for pulling the trolley case over a flat surface 100 because the centre of gravity is in between the wheels 20 and the handle-frame 90. The trolley case may not topple over small hurdles, bumps, etc. This position is also better for storing the case in relatively tight spaces, like under the seats of a passenger train.

If we turn the open-frame 54 in the direction shown by the double arrow in FIG. 9, we change the position to that shown in FIG. 10. This position shown in FIG. 10 is for carrying the trolley case over stairs.

In the position shown in FIG. 10, a powerful magnet 48 on one side is locked with a powerful magnet 46 on the same side. Another powerful magnet 48 on the other side is locked with another powerful magnet 46 on that other side. This keeps the open-frame 54 with two wheels 20 in a position that is perpendicular to the longest side of the body 80.

This position is not ideal for storing the case in relatively tight spaces, like under the seats of a passenger train. Though this position may prevent the bottom from getting soiled if we fix one or two small block-feet 88 further from the wheels 20 on the bottom side.

This position is also not ideal for pulling the case over a flat surface as the center of gravity of the trolley case may not always remain in-between the wheels 20 and handle-frame 90. It may become somewhat difficult to carry the trolley case on rough surfaces. But this position is better for pulling the case over stairs.

We can turn the open-frame 54 in the direction opposite to the direction shown in FIG. 9 to easily carry the trolley case again over flat surfaces.

The main difference between this embodiment and most other embodiments is that, to accommodate for the edges of the stairs, the open-frame (54 in this case) or the bars carrying wheels are turned around a pivot 70 in this case, while in many other embodiments the open-frames are linearly extended to provide for the edges of the stairs.

We may position the magnets 46 on the sides of the body 80 as shown in FIG. 16. In this position, the open-frame 54 will lock in a position that is not exactly perpendicular to the body 80. We may change the position of the magnets 44 so that the open-frame 54 will lock in a position that is not exactly parallel to the body 80.

The preferred embodiment is shown in FIGS. 13 and 14. In this embodiment, the outer two sides of the three sided open-frame 56 are curved bars instead of the straight bars employed in other embodiments discussed earlier. To accommodate these curved sides, the two built-in encompassing tubes 64 are also curved.

As previously stated, such encompassing tubes 64 can be viewed as sockets or channels built into the body 80. These tubes 64 are designed to hold the two sides of the three-sided open-frame 56 while allowing for the retraction and extension of the same open-frame 56.

The locking mechanisms, which are preferably embedded in the tubes, are not shown to keep these illustrations simple and clear. We need to have locking mechanisms for both the retracted and extended positions. Similar locking mechanisms as employed for the exemplary embodiment or variant of the exemplary embodiment may be used. Instead of locking magnets we may have magnets and iron-blocks locking with each other.

On the bottom side of the trolley case, there are two pockets or pits 86 spaced apart. As we can see, the wheels 24 attached to a three-point star hub 26 are horizontally spaced apart from the wheels 24 attached to the other three-point star hub 26. The centres of the two pits 86 are exactly the same distance apart horizontally as the centres of the two three-point star hubs 26.

FIG. 13 shows that the two lower wheels 24 attached to both the three-point star hubs 26 are touching the ground. While the third wheel on both of these three-point star hubs 26 are above them.

In each of the pits 86, one of the wheels 24 mounted on the three-point star hub 26 near it can enter when the open-frame 56 is retracted. The wheels 24 within the pits 86 can be called the upper wheels.

These pits 86 are unlike wheel wells of a typical vehicle. A wheel of a vehicle rotates within its wheel well; while the pit or pocket 86 are not designed for the wheel 24 of the trolley case to rotate in it.

When the upper wheels 24 attached to the three-point star hubs 26 are in the pockets or pits 86, the three-point star hubs 26 cannot rotate. This position is ideal for pulling the trolley case on a flat surface 100. In this case, the wheels of two tri-wheel star assemblies which are not in the pits let the trolley remain stationary vertically or moved vertically on four wheels (two wheels of two tri-wheel star assemblies each) or moved tilted on two wheels (one wheel of two tri-wheel star assemblies each).

The wheel pockets (pits) may not completely accommodate the wheels; they could be only deep enough to stop the rotation of the tri-wheel star assembly. This embodiment has most of the features of the present invention.

Pockets or pits can be created in embodiments similar to those shown in FIGS. 11 and 12. But the position of those pits won't be exactly similar to the position here.

FIG. 15 shows another embodiment. It is a side view. This embodiment has two independent bars 58 on the lower end of both the longer sides of the trolley case. Each of the bars 58 has a wheel 20 at the free end. These bars 58 with wheels 20 can slide or move within the channels or tracks 66. These sliding bars 58 can be extended from the bottom side of the trolley case and retracted completely within the boundary of the case. These sliding bars 58 shown in FIG. 15 are in the extended position, so the wheels 20 are further from the body 80. This state is ideal for dragging the trolley case over stairs as well as on flat ground.

The advantage of using two independent sliding bars instead of a sliding open-frame is that the wheels can simply be retracted inside the bounds (boundary) of the trolley case completely without providing a recess or pit for the middle side. This facilitates the storage of the trolley case in tighter spaces. But a shiftable open-frame can also be used like most other embodiments. We may use any of the locking arrangements used in other embodiments (mentioned earlier) or of any other variety with this embodiment.

We can have three locking positions instead of two locking positions of other embodiments. The innermost locking will completely retract the wheels 20 inside the bounds of the trolley case, which is ideal for storing the trolley case. The extreme extended position will take the wheels 20 furthest from the body, which will be helpful in providing space for the edges of the stairs. So locking in this extended position will be helpful in dragging the trolley case over the stairs, particularly upstairs. There can be a locking position in between the completely retracted and completely extended positions. So, locking in this middle position will let us easily drag the trolley case over flat surfaces.

1-7. (canceled)

8. A wheel assembly configured to be coupled to a movable object for facilitating an ascent or descent of the movable object over stairs, the wheel assembly comprising:
an open-frame comprising three members, including a middle member that serves as an axle and a pair of side members coupled to opposite ends of the middle member, the side members being parallel to one another;
a pair of parallel tubes encompassing and supporting the pair of side members, wherein the pair of parallel tubes allow the open-frame to be slidably extended away from and retracted back toward the movable object when the pair of parallel tubes are embedded in the movable object;
one or more wheels or multi-wheel star assemblies coupled to the middle member of the open-frame; and
a lock comprising a first locking component embedded in the open-frame and a second locking component embedded in one or both tubes of the pair of parallel tubes, the first and second locking components configured to secure the open-frame in an extended position for facilitating an ascent or descent of the movable object over stairs.

9. The wheel assembly of claim 8, wherein the lock comprises a notch-and-plunger mechanism, a pin-and-hole mechanism, a magnet and iron-strip combination, an electro-mechanical mechanism, or an electro-magnetic mechanism.

10. The wheel assembly of claim 8, wherein each side member of the pair of side members comprises a first portion that is coupled to the middle member and a second portion extending from the first portion, wherein the first and second portions are bent at an angle with respect to one another.

11. A wheel assembly configured to be coupled to a movable object for facilitating an ascent or descent of the movable object over stairs, the wheel assembly comprising:
an open-frame comprising three members, including a middle member that serves as an axle and a pair of side members coupled to opposite ends of the middle member, the side members being parallel to one another;
a first pivot for coupling a first side member of the pair of side members to the movable object and a second pivot for coupling a second side member of the pair of side members to the movable object, wherein the first and second pivots are configured to facilitate a pivoting of the open-frame relative to the movable object;
one or more wheels or multi-wheel star assemblies coupled to the middle member of the open-frame; and
a lock comprising a first locking component embedded in the open-frame and a second locking component coupled to the first pivot and/or second pivot, the first and second locking components configured to secure the open-frame in a position that increases distance between the movable object and stairs for facilitating an ascent or descent of the movable object over the stairs.

12. The wheel assembly of claim 11, wherein the lock comprises a notch-and-plunger mechanism, a pin-and-hole mechanism, a magnet and iron-strip combination, an electro-mechanical mechanism, or an electro-magnetic mechanism.

13. A luggage, comprising:
a body;
a wheel assembly comprising one or more wheels or multi-wheel star assemblies, the wheel assembly further comprising a U-shaped frame having a middle member that serves as an axle for the one or more wheels or multi-wheel star assemblies and a pair of side members coupled to opposite ends of the middle member, the pair of side members being parallel to one another;
wherein the body comprises a pair of tubes or a pair of channels, the pair of tubes or channels being configured to receive the pair of side members of the U-shaped frame, and to allow the U-shaped frame to be movable from a first position that is extended away from the body and a second position that is retracted toward the body; and
a lock comprising a first locking component embedded in the U-shaped frame and a second locking component embedded in one or both tubes or channels of the two parallel tubes or channels, the first and second locking components configured to secure the U-shaped frame in the first position for facilitating an ascent or descent of the movable object over stairs.

14. The luggage of claim 13, wherein the wheel assembly comprises one or more multi-wheel star assemblies, and the body further comprises an internal pocket for each of the multi-wheel star assemblies, the pocket configured to receive a wheel of the respective multi-wheel star assembly.

15. The luggage of claim 14, wherein each pocket is configured to prevent the respective multi-wheel star assembly from rotating.

16. The luggage of claim 13, wherein the lock comprises a notch-and-plunger mechanism, a pin-and-hole mechanism, a magnet and iron-strip combination, an electro-mechanical mechanism, or an electro-magnetic mechanism.

17. The luggage of claim 13, wherein the body comprises a base panel having a pair of through-holes configured to receive the pair of side members of the wheel assembly.

18. The luggage of claim 13, further comprising an extendable and retractable handle for controlling the luggage during transport, the handle comprising a magnetic lock to maintain the handle in a position that is extended away from the body and a mechanical lock to maintain the handle in a position that is retracted toward the body.

19. The luggage of claim 13, wherein each side member of the pair of side members comprises a first portion that is connected to the middle member and a second portion extending from the first portion, wherein the first and second portions are bent at an angle with respect to one another.

20. The luggage of claim 19, wherein the angle is such that it increases a spaced distance between the body and the stairs when the luggage is ascending or descending the stairs relative to when the first and second portions are not bent at an angle with respect to one another.

21. A luggage, comprising:
a body;
a wheel assembly comprising one or more wheels or multi-wheel star assemblies, the wheel assembly further comprising a U-shaped frame having a middle member that serves as an axle for the one or more wheels or multi-wheel star assemblies and a pair of side members coupled to opposite ends of the middle member, the pair of side members being parallel to one another;
wherein the body comprises a pair of pivots, including a first pivot for coupling a first side member of the pair of side members to the body and a second pivot for coupling a second side member of the pair of side members to the body, wherein the first and second pivots are configured to facilitate a pivoting of the U-shaped frame relative to the body;
a lock comprising a first locking component embedded in the U-shaped frame and a second locking component and a third locking component coupled to the body, wherein the first and second locking components are configured to secure the U-shaped frame in a position that increases the distance between the body and stairs for facilitating an ascent or descent of the luggage over the stairs, and wherein the first and third locking components are configured to secure the U-shaped frame in a position for facilitating movement of the luggage over a flat surface.

22. The luggage of claim 21, wherein the wheel assembly comprises one or more multi-wheel star assemblies, and the body further comprises an internal pocket for each of the multi-wheel star assemblies, the pocket configured to receive a wheel of the respective multi-wheel star assembly.

23. The luggage of claim 22, wherein each pocket is configured to prevent the respective multi-wheel star assembly from rotating.

24. The luggage of claim 21, wherein the lock comprises a notch-and-plunger mechanism, a pin-and-hole mechanism, a magnet and iron-strip combination, an electro-mechanical mechanism, or an electro-magnetic mechanism.

25. The luggage of claim 21, wherein the body comprises a base panel having a pair of through-holes configured to receive the pair of side members of the wheel assembly.

26. The luggage of claim 21, further comprising an extendable and retractable handle for controlling the luggage during transport, the handle comprising a magnetic lock to maintain the handle in a position that is extended away from the body and a mechanical lock to maintain the handle in a position that is retracted toward the body.

27. The luggage of claim 21, wherein each side member of the pair of side members comprises a first portion that is connected to the middle member and a second portion extending from the first portion, wherein the first and second portions are bent at an angle with respect to one another and the angle is such that it increases a spaced distance between the body and the stairs when the luggage is ascending or descending the stairs relative to when the first and second portions are not bent at an angle with respect to one another.
